(19) United States
(12) Patent Application Publication
(10) Pub. No.: US 2015/0060376 A1
(43) Pub. Date: Mar. 5, 2015

(54) BIRTHDAY CARD DISPLAY

(71) Applicant: Heidi Hall, Robertsdale, AL (US)

(72) Inventor: Heidi Hall, Robertsdale, AL (US)

(21) Appl. No.: 14/010,838

(22) Filed: Aug. 27, 2013

(51) Int. Cl. G09F 1/10; A47F 5/10; A47F 5/01

(52) U.S. Cl. CPC G09F 1/10; A47F 5/01; A47F 5/10
USPC 211/45

(57) ABSTRACT

A series of circular loops, where each loop is capable of receiving a card; a wire between the circular loops where the wire coils in order to create each circular loop to create the card display; and a backside, where the backside support the card display. In the preferred embodiment, each circular loop is configured to receive a card. The backside may be split into two sides joined by a hinge.

### BACKGROUND OF THE INVENTION

1. Field of Invention

The present invention relates to a birthday card display used to store and display greeting cards.

2. Description of Related Art

Greeting cards are a popular gift that is used to recognize individuals and organizations on particular holidays and special occasions. Greeting cards are used for Christmas, New Year's, birthdays, anniversaries, deaths and numerous other occasions. Many times greeting cards are given as an expression of encouragement, recognition or thoughts in association with a particular event or occasion. The receiver of the greeting card normally enjoys the card for the occasion and eventually the card is discarded or misplaced. Although greeting cards have numerous displays and advertising kiosks in a retail environment, the consumer who actually may receive the greeting card has limited options in displaying and storing greeting cards that may be received for any particular occasion. The present invention provides a great method to store and display greeting cards for the consumer.

### SUMMARY OF THE INVENTION

The present invention relates to a greeting card display for displaying cards comprising: a series of circular loops, where each loop is capable of receiving a card; a wire between the circular loops where the wire coils in order to create each circular loop to create the card display; and a backside, where the backside support the card display. In the preferred embodiment, each circular loop is configured to receive a card. The backside may be split into two sides joined by a hinge.

### BRIEF DESCRIPTION OF DRAWINGS

FIG. 1 depicts a greeting card display device in accordance with the present invention.

FIG. 2 depicts a side view of the greeting card display according to the present invention.

### DETAILED DESCRIPTION

The present invention relates to a greeting card display that provides a series of circular loops that are connected which receive greeting cards for display. The greeting card display according to the present invention further is supported through a stand. The stand includes a back side to support the display during use.

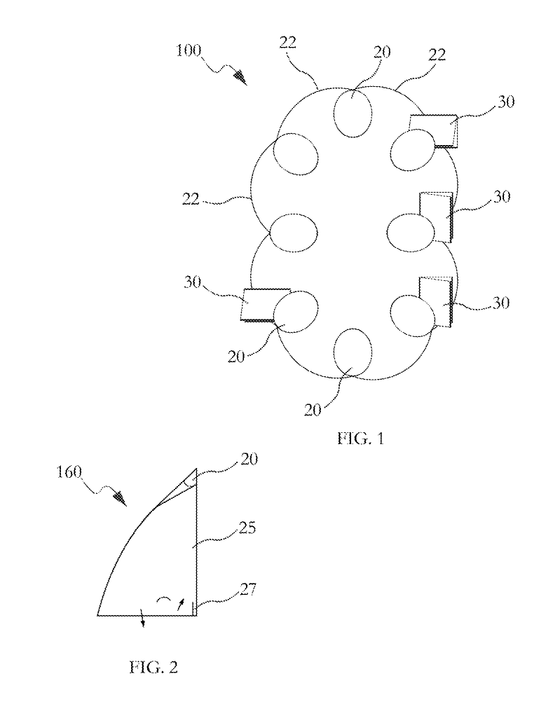

In reference to FIG. 1 a greeting card display 100 is depicted in accordance with the present invention. The greeting card display 100 includes a series of circular loops 20 that are connected through a wire that coils upon itself to create each respective loop. The circular loops as depicted in FIG. 1 create a circular shape so that a card 30 may be inserted into each loop for display. The display may include backside 25 as shown in FIG. 2. The backside 25 is essentially two sides meeting at a hinge 27 depicted in FIG. 2. The hinged backside 25 supports the wire and series of circular loops formed provided on the front side of the greeting card Display 100. A user may simply insert a card 30 as shown in any of the circular loops 20 that surround the perimeter of the card Display 100. The card display provides a device that allows a user to showcase their greeting cards after receiving them from various individuals. The display may be placed on a flat surface or due to the hinge 27 mounted on a wall for a wall display. This construction allows the display to be placed in different environments such as schools, households or offices as a display for greeting cards that are received. Such a display is especially effective during the Christmas and New Year holiday where a significant amount of greeting cards are sent to various receivers. The instant invention has been shown and described in what it considers to be the most practical and preferred embodiments. It is recognized, however, that departures may be made there from within the scope of the invention and that obvious modifications will occur to a person skilled in the art.

1. A greeting card display for displaying cards comprising:
a. a series of circular loops, where each loop is capable of receiving a card;
b. a wire between the circular loops where the wire coils in order to create each circular loop to create the card display; and
c. a backside, where the backside support the card display.

2. The greeting card display according to claim 1, where each circular loop is configured to receive a card.

3. The greeting card display according to claim 1, where the backside is split into two sides joined by a hinge.
